(19) United States
(12) Patent Application Publication
(10) Pub. No.: US 2007/0131008 A1
(43) Pub. Date: Jun. 14, 2007

(54) Anti-pick lock devices and methodologies

(75) Inventors: Robert Brunke, Naperville, IL (US); Christina A.C. Haiduc, Chicago, IL (US); Francis H. Zimmerman, Libertyville, IL (US); Thomas P. Butler, Bartlett, IL (US)

Correspondence Address: DORITY & MANNING, P.A., POST OFFICE BOX 1449, GREENVILLE, SC, 29602-1449, US

(73) Assignee: CompX International Inc., Mauldin, SC (US)

(21) Appl. No.: 11/586,420

(22) Filed: Oct. 25, 2006

Related U.S. Application Data
(60) Provisional application No. 60/750,103, filed on Dec. 14, 2005.

(51) Int. Cl. E05B 27/08

(52) U.S. Cl. 70/491

(57) ABSTRACT

Disclosed are apparatus and methodology for providing an improved pick-resistant lock structure. Contact edges associated with individual combination and driver pins are moved away from the true shear lines to deny a lock picker the ability to feel any contact between a selected pin and a pin hole edge. Methodologies and apparatus are also provided to prevent a lock picker from obtaining an impression of the lock shear plane.

### PRIORITY CLAIM

This application claims the benefit of previously filed U.S. Provisional Patent Application entitled “IMPROVED ANTI-PICK LOCK DEVICES AND METHODOLOGIES,” assigned U.S. Ser. No. 60/750,103, filed Dec. 14, 2005, and which is incorporated herein by reference for all purposes.

### FIELD OF THE INVENTION

The present subject matter relates to locks. More particularly, the present subject matter relates to pick resistant locks having improved pin-tumbler configurations, and corresponding and/or related methodologies.

### BACKGROUND OF THE INVENTION

Generally speaking, the use of various lock structures is well known in a number of different environments, for a large variety of items for which various forms of protection (i.e. physical security) is desired. Locks of many different types have been in existence for hundreds of years. Unfortunately, for just as long a period of time, there have been individuals who have sought to defeat or “pick” such locks, in order to illicitly gain access to the protected item or area for which or on which the lock was installed.

U.S. Pat. No. 4,085,601 (Sauder) is entitled “Nonpickable Lock” and discloses what it describes as a nonpickable lock device comprising a housing, a plug rotably mounted in the housing and having an axially extending keyway, tumblers (disposed for reciprocal movement within cross bores formed in the plug for blocking rotation of the plug unless a properly bitted key is inserted in the keyway), and tumbler biasing means mounted in clearance slots formed in the plug in registry with the tumblers.

U.S. Pat. No. 4,584,855 (Burlingame) is entitled “Pick-Proof Locking System” and discloses what it describes as a pick-proof u-bolt type lock with an untypical location for containing its cylinder lock. A tube, comprising a housing, has openings near its ends that accept the ends of a shackle which are secured within that housing. A cylinder lock is located between the shackle openings and an access port is provided to it for insertion and withdrawal of the key. A matching port on a collar that rotates around the housing is positioned to shut off that access, or to allow it selectively. Cooperating parts attached to, and effecting the operation of the lock, work to make the lock inoperable while access to the keyhole is available; and allow normal function of the lock when rotation of the collar prevents access. The key is not turned by finger grip, but instead, affecting the closure, turns the key and plug operating the cylinder lock and releasing the shackle at one end. The remaining end is freed as it swings clear of a securing pin in the other end of the housing. An enclosed operating key may continue to remain attached to an outside device, such as a key ring, a narrow slot through which the connection may pass is provided on the perimeter of the access port.

U.S. Pat. No. 4,972,695 (Mochida et al.) is entitled “Anti-Pick Cylinder Lock” and discloses what it describes as a cylinder lock which is proofed against lock pickers. The cylinder lock comprises a case having a cylindrical bore formed therein and an axially extending lock groove exposed to the cylindrical bore; a rotor rotatably disposed in the cylindrical bore; a plurality of tumblers slidably received in slits formed in the rotor, each tumbler having a head which is projectable into the lock groove when the rotor assumes a given angular position relative to the case; springs for biasing the tumblers radially outward from the slits of the rotor; and a structure for making the distances by which the heads of the tumblers are projected into the lock groove of the case different from one another.

U.S. Pat. No. 5,138,856 (Chyun) is entitled “Anti-Pick Lock” and discloses what it describes as a lock including a sleeve fixed in the body and having a number of orifices, a stud and a spring received in each of the orifices, a barrel received in the sleeve and including a number of apertures and a bore for rotatably receiving a core which includes a notch, and a key engageable with the notch of the core and including a number of depressions, the barrel can not be rotated when the studs are engaged between the sleeve and the barrel, and the barrel can be rotated when the studs are biased to engage within the apertures of the barrel.

U.S. Pat. No. 4,444,029 (Remington) is entitled “Combination Lock With Anti-Pick Feature” and discloses a combination padlock with dial-driven rotary sleeves mounted within a lock casing on a longer leg of a padlock shackle. The sleeves have peripheral teeth with at least one tooth being omitted on each sleeve to define a bypass gap. To open the lock, the dials must be rotated so as to turn each of the bypass gaps into alignment with a respective blocking projection in the lock casing. To thwart any attempt to pick the lock, alternate teeth on each sleeve are shorter than the adjacent teeth whereby a detent-type feel may be produced when the sleeve is rotated, simulating the feel produced when the bypass gap is brought into line with the respective blocking projection.

U.S. Pat. No. 5,979,200 (Cliff), commonly owned with the present subject matter, is entitled “Axial Pin Tumbler Removable Core Lock” and discloses a removable core, axial pin tumbler lock that includes an inner cylinder assembly which is retained within a housing for the lock by means of a spring biased disc which may be decoupled from the housing by means of insertion of a pick through a passageway defined in the inner cylinder assembly when the components parts of the assembly are appropriately aligned.

While various implementations of anti-pick locks have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved apparatus and methodology has been provided for lessening the likelihood that a lock may be opened by means other than by use of a particular key configured specifically for the lock. More particularly, an improved apparatus and methodology has been provided to prevent a lock from being opened, i.e. picked, by any individual not authorized to have controlling access to the lock.

In certain broader present aspects, it is a present object to provide a pin-tumbler configuration that inhibits a potential lock picker from determining the shear line plane associated with individual pin tumblers by generally shifting away from the actual shear line plane the point at which a lock picker might attempt to feel the contact point of a pin edge and an edge of a pin tumbler hole.

In certain aspects, another more particular present object of various present exemplary forms is to provide tumbler-pin configurations in accordance with present subject matter which have a relatively reduced diameter or step configuration, preferably extending in a direction away from the actual shear line plane. A more particular object in certain embodiments is to provide such an advantageous relatively reduced diameter or step tumbler-pin configuration which extends a predetermined distance in a direction away from the actual shear line plane.

Another present broader object of various of the present exemplary embodiments is to provide a device that has a combination pins and driver pins configured such that no pin edge is present at the shear line plane of any pin, thus eliminating any possibility of locating the shear line plane by feel from manipulation of the lock with known types of so-called picking tools.

In accordance with further broader objects, aspects, and advantages of certain embodiments of the present subject matter, methodologies are provided which advantageously deny a would-be lock picker at least one aspect of sensory assistance in picking a lock provided in accordance with certain aspects of the present subject matter.

In accordance with certain aspects of other embodiments of the present subject matter, methodologies have been developed and are advantageously provided to hide the true shear line plane of individual combination and driver pins from an attacker.

In accordance with yet additional objects, aspects, and advantages of further exemplary embodiments of the present subject matter, apparatus and accompanying methodologies have been developed to impede the discovery by an attacker of a shear line plane through the use of impression-taking techniques involving impressionable soft materials. Thus, in certain aspects, the present subject matter in pertinent part may be regarded as “time based” or as having a time based component or aspect, in that the technology in such respects is intended to slow down or delay (i.e.impede) attempts of lock picking by unauthorized persons.

According to yet still other objects and aspects of additional embodiments of the present subject matter, apparatus and methodologies have been developed to impede the insertion of impressionable materials fully into the lock so that such materials can not reach the key insertion plane as part of an effort to obtain an impression of the lock combination.

One present exemplary embodiment relates to an axial pin tumbler lock with anti-pick features for inhibiting attack, such a lock comprising a cylinder housing, at least one pair of alignable grooves, at least one pair of tumbler pins, spring means, and anti-pick means in accordance with the present subject matter. In such exemplary embodiment, preferably the cylinder housing defines a longitudinal axis, and includes respective top and bottom cylinder portions having a common shear plane formed therebetween for rotatable movement of such cylinder portions relative to one another about such longitudinal axis, for placing such lock alternately into locked and unlocked positions thereof. Such at least one pair of alignable grooves preferably are formed in such respective cylinder portions, and longitudinally aligned along such longitudinal axis. Such at least one pair of tumbler pins preferably comprise a combination and driver pin pair, slidably received respectively in such alignable grooves, with such combination pin received primarily in such top cylinder portion and such driver pin received primarily in such bottom cylinder portion such that placement of the junction between such combination and driver pin pair at such common shear plane permits relative rotatable movement of such top and bottom cylinder portions.

In the foregoing exemplary embodiment, preferably such spring means are provided for biasing such driver pin towards such combination pin, while such anti-pick means are provided for inhibiting an attacker's ability to determine a shear line plane for such combination and driver pin pair by moving the contact point felt by an attacker to a plane different from that of such common shear plane.

Still further regarding such exemplary embodiment, in various implementations thereof such anti-pick means preferably comprises a relatively reduced diameter step section formed on at least one of such combination and driver pins, while in additional aspects such relatively reduced diameter step section may be formed a predetermined distance from an end of such at least one of such combination and driver pins.

In the foregoing exemplary embodiment, in some implementations thereof, such spring means may preferably comprise a spring received with such driver pin in one of such at least one pair of alignable grooves formed in such bottom cylinder portions, longitudinally aligned along such longitudinal axis. Still further, in some implementations, an end portion of such driver pin has a relatively reduced diameter portion for partial insertion of such driver pin into a corresponding end portion of such spring.

In yet additional implementations of the foregoing, such a lock may be provided with a plurality of pairs of such alignable grooves, formed in such respective cylinder portions, longitudinally aligned along such longitudinal axis; and with a corresponding plurality of pairs of such tumbler pins comprising respective associated combination and driver pins for each of such pairs, slidably received respectively in such corresponding plurality of such alignable grooves, with such combination pins received primarily in such top cylinder portion and such driver pins received primarily in such bottom cylinder portion such that placement of the junctions between such respective combination and driver pin pairs at such common shear plane permits relative rotatable movement of such top and bottom cylinder portions, for placing such lock alternately into locked and unlocked positions thereof. In such exemplary arrangement, preferably such anti-pick means also comprise a plurality of relatively reduced diameter step sections respectively formed on a plurality of such combination and driver pins.

In yet another present exemplary embodiment, an axial pin tumbler lock with anti-pick features for inhibiting attack may include a cylinder housing defining a longitudinal axis, such cylinder housing including respective top and bottom cylinder portions having a common shear plane formed therebetween for rotatable movement of such cylinder portions relative to one another about such longitudinal axis, for placing such lock alternately into locked and unlocked positions thereof; a plurality of pairs of alignable grooves, formed in such respective cylinder portions, longitudinally aligned along such longitudinal axis; a corresponding plurality of pairs of tumbler pins comprising respective associated combination and driver pins for each of such pairs, slidably received respectively in such corresponding plurality of such alignable grooves, with such combination pins received primarily in such top cylinder portion and such driver pins received primarily in such bottom cylinder portion such that placement of the junctions between such respective combination and driver pin pairs at such common shear plane permits relative rotatable movement of such top and bottom cylinder portions, for placing such lock alternately into locked and unlocked positions thereof; spring means; and a plurality of relatively reduced diameter step sections.

In the foregoing exemplary embodiment, such spring means are preferably provided for biasing such driver pins towards such respectively associated combination pins, while such plurality of relatively reduced diameter step sections preferably are respectively formed on a plurality of such combination and driver pins for moving the contact points felt by an attacker to one or more planes different from that of such common shear plane, so as to inhibit an attacker's ability to determine a shear line plane for a given combination and driver pin pair.

In yet additional implementations of the foregoing, such exemplary embodiment may further include at least one protrusion defined by such cylinder housing and situated for preventing a lock attacker from inserting soft, impressionable materials adequately into the lock so as to obtain an impression of the shear plane of the lock.

Other present exemplary embodiments relate to methodology, with one exemplary such method relating to a method for providing a tumbler lock with anti-pick features for inhibiting attack. Such exemplary method may preferably comprise the steps of providing a lock, such lock having a main housing defining respective portions having a common pin shear plane formed therebetween for movement of such portions relative to one another, for placing such lock alternately into locked and unlocked positions thereof, having at least one pair of tumbler pins comprising a combination and driver pin pair and movably received in such housing such that placement of the junction between such combination and driver pin pair at the common pin shear plane permits relative movement of the respective housing portions; and providing a relatively reduced diameter step section formed on at least one of the combination and driver pins for moving the contact point felt by an attacker to a plane different from that of such common pin shear plane, so as to inhibit an attacker's ability to determine a shear line plane for such combination and driver pin pair.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the present subject matter applies equally to corresponding methodologies as associated with practice of any of the present exemplary devices, and vice versa.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of an exemplary combination pin for a lock in accordance with the present subject matter;

FIG. 2 is a perspective view of an exemplary driver pin for a lock in accordance with the present subject matter;

FIG. 3 is an isometric, generally front view of an exemplary top cylinder for a lock constructed in accordance with the present subject matter;

FIG. 4 is an isometric, generally rear view of an exemplary top cylinder for a lock constructed in accordance with the present subject matter;

FIGS. 5(a), 5(b), and 5(c) are left end, side, and right end views, respectively, of an exemplary combination pin for a lock constructed in accordance with the present subject matter;

FIGS. 6(a), 6(b), and 6(c) are left end, side and right end views, respectively, of an exemplary driver pin for a lock constructed in accordance with the present subject matter;

FIG. 7(a) is an isometric view (externally only) of an exemplary known tubular lock with the illustration of a key inserted therein;

FIG. 7(b) is a partially cut away illustration of an exemplary known tubular lock with tumbler pins thereof shown in a locked position and with a removed key illustrated adjacent thereto; and

FIG. 7(c) is a partially cut away illustration of an exemplary known tubular lock with tumbler pins thereof shown in an unlocked position and with an illustrated key shown in an inserted position.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved apparatus and methodology to prevent a lock from being opened, i.e., picked, by any individual not authorized to have controlling access to the lock. In related aspects, the present subject matter may relate to time based considerations of how the subject matter is implemented—in other words, it's meant to impede or slow down attempts of unauthorized persons to pick the lock.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices, features, or steps not expressly mentioned which perform the same or similar function.

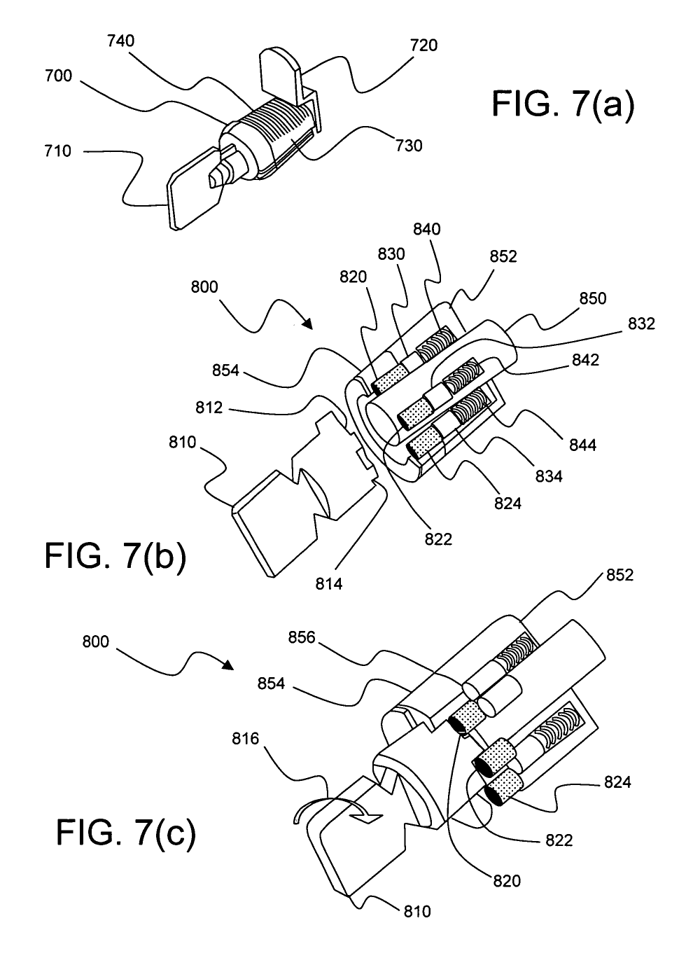

Reference will now be made in detail to the presently preferred embodiments of the subject anti-pick lock structure. Referring now to the drawings, FIGS. 7(a), (b), and (c) will first be explored to provide a general understanding of an exemplary environment in which the anti-pick technology in accordance with the present subject matter may be employed.

Each of the FIGS. 7(a)-(c), respectively, represent various views of an exemplary tubular lock in which the subject matter of the present technology may be employed. It should be clearly understood, however, that representation of use of the present subject matter in tubular locks is not a limitation of the present subject matter as the disclosed technology may more generally be employed in any lock employing pins whose operation is dependent on aligning a pin shear plane with corresponding lock components to allow opening of the lock.

With reference first to FIG. 7(a), there is illustrated an external view of a tubular lock 700 with a corresponding key 710 inserted therein. Tubular lock 700 may have at least one flattened side portion 730 are similar feature for preventing a mounted lock from rotating while inserted into a correspondingly shaped opening. Portions of the external surfaces of the lock 700 may be threaded as at 740 to accommodate a retaining nut (not shown). The lock 700 may also include a cam 720 attached for rotation between locked and unlocked positions upon corresponding rotation of a properly coded key 710.

With reference now to FIG. 7(b), there is illustrated a partially cut away view of a tubular lock 800 and corresponding key 810 similar to that shown in FIG. 7(a) but with the key 810 removed from the lock and with pertinent features of the lock in a locked position. Specifically, combination pins 820, 822, and 824, and driver pins 830, 832, and 834 respectively associated therewith, are urged toward the front of the lock 800 respectively by springs 840, 842, and 844 encased with portions of driver pins 830, 832, and 834 in holes (unnumbered) in bottom cylinder portion 852 of lock 800, all thereby preventing the lock plug 850 from rotating. Combination pins 820, 822, and 824 are at least partially encased in pin tumbler holes (not presently shown) within top cylinder portion 854 of lock 800. The tubular key 810 has several half-cylinder indentations 812, 814 which align with the pins 820, 822, and 824.

With reference now to FIG. 7(c), there is illustrated a partial cut away view of tubular lock 800 with the key 810 inserted and with pertinent features of the lock in an unlocked position. In such configuration, the combination and driver pins are correctly aligned for unlocking of the lock 800 by insertion and clockwise rotation of tubular key 810 (as illustrated by arrow 816). Rotation of the lock top cylinder 854 and contained combination pins 820, 822, and 824 relative to bottom cylinder 852 is permitted due to the common shear plane 856 alignments of all of the combination and driver pin pairs. As is well understood by those of ordinary skill in the art, various combinations of lengths for the combination and driver pins provide numerous combinations for multiple similar locks.

In accordance with the present subject matter, it has been found that attackers may gain access to tumbler locks similar to those representatively illustrated in FIGS. 7(a) through (c) by using specially designed picks and by individually pressing the combination pins with picks while applying a slight rotational motion to the lock cylinder. This combination of activities will, in prior art structures, allow an attacker to feel the small contact that occurs between the edge of each pin tumbler and the edge of the pin tumbler hole of either the top or bottom cylinder components. The present subject matter provides methods and structures that inhibit an attacker's ability to determine the shear line plane for individual combination and driver pin pairs by moving the contact point felt by attackers to a plane different from the actual shear line plane.

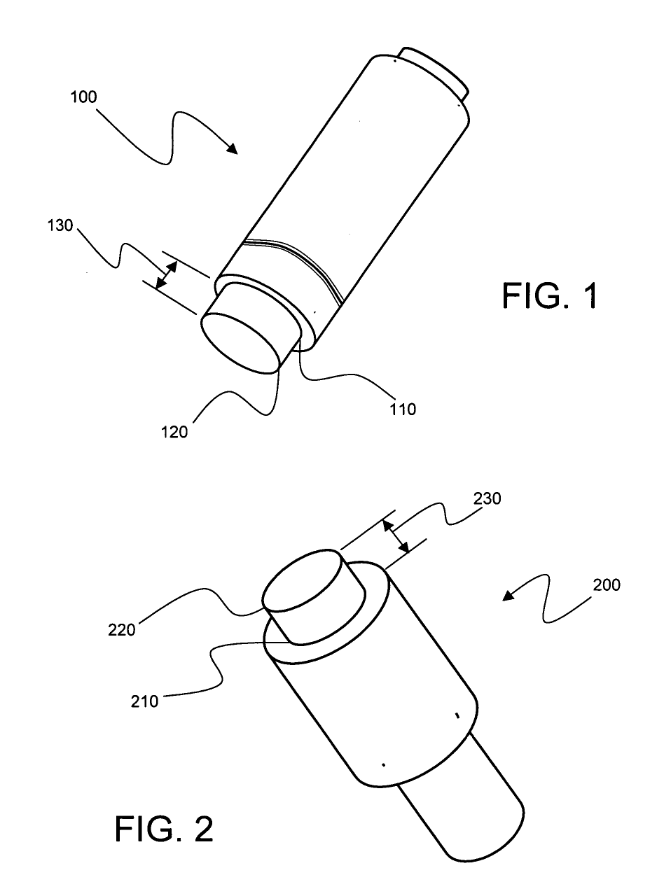

With reference now to FIG. 1, there is illustrated a perspective view of an exemplary combination pin 100 constructed in accordance with the present technology. As may be seen from FIG. 1, combination pin 100 includes a step 110 corresponding to a reduced combination pin diameter portion extending from the end 120 of combination pin 100 and, in this exemplary embodiment, for a first predetermined distance 130 in a direction away from end 120. FIG. 2 illustrates a similar arrangement with respect to an exemplary driver pin 200. Such exemplary driver pin 200 is in accordance with present subject matter is provided with a step 210, corresponding to a reduced diameter driver pin portion extending from the end 220 of driver pin 200, and for a second predetermined distance 230 in a direction away from end 220. The first and second predetermined distances 130 (FIG. 1) and 230 (FIG. 2), respectively, are not necessarily equal in length although equal lengths are also contemplated per the present subject matter.

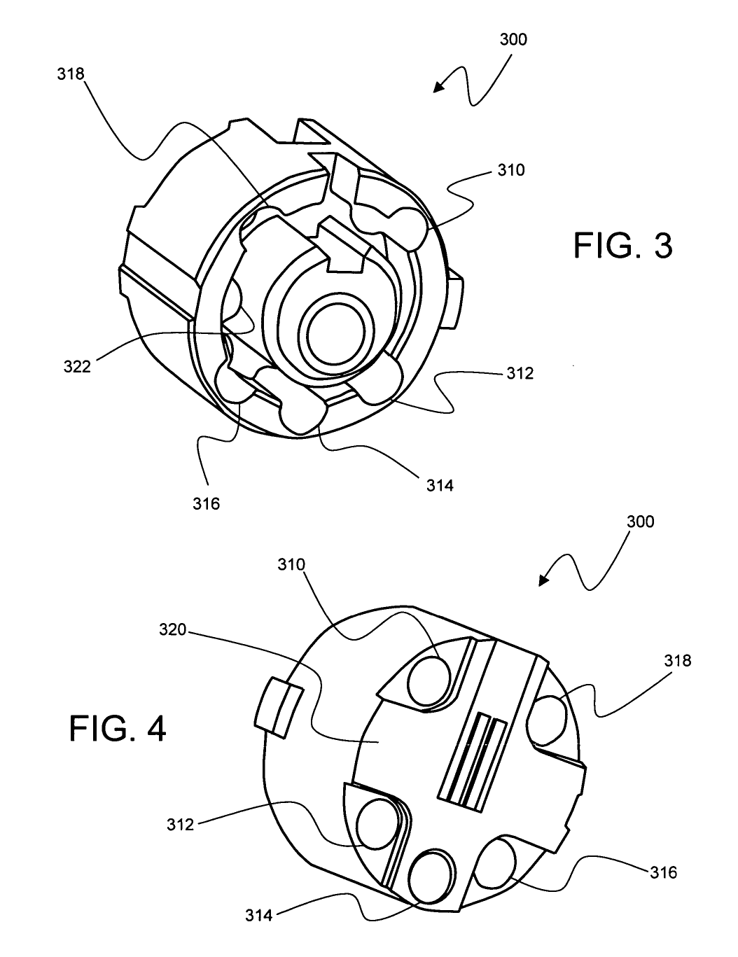

With reference to FIG. 3, there is illustrated an isometric, generally front view of a top cylinder 300 as may be employed in a lock constructed in accordance with the present subject matter. As may be seen from FIG. 3, a number of pin tumbler holes 310, 312, 314, 316, 318 are provided around the perimeter of top cylinder 300. Pin tumbler holes 310-318 are configured to receive combination pins of varying lengths similar to that illustrated in FIG. 1.

Referring to FIG. 4, there is illustrated an isometric, generally rear view of top cylinder 300. Also appearing in the representation of FIG. 4 are pin tumbler holes 310 through 318, which extend completely through selected perimeter portions of the top cylinder 300. Surface 320 is the shear line for the exemplary lock in accordance with present subject matter. In other words, surface 320 in part establishes such shear line plane, when appropriately associated with a mating surface from a corresponding bottom cylinder (not shown, but similar to bottom cylinder 852 of FIGS. 7(b) and (c)), and in which shear line plane all of the combination and driver pin pairs' abutment planes must simultaneously reside in order for the lock to be opened.

Returning now to FIGS. 1 and 2, operational aspects of the anti-pick lock structure and methodology provided in accordance with the present technology can be more readily seen considering the assembled relationship of the combination pins 100 relative to the pin tumbler holes 310 through 318. As previously mentioned, one of the aspects of previous lock structures that allowed successful attack of the lock by lock pickers was the detectable contact of edge portions of the combination and driver pins with edge portions of the pin tumbler holes. Such aspect of devices as previously available to lock pickers has been eliminated by the present technology.

With reference to FIGS. 1 and 3, with the inclusion of step 110 in combination pin 100, it can be seen that while the detectable contact between pin and pin hole edges still may occur, such contact no longer identifies the shear line that must otherwise be located in order to successfully open the lock. Such beneficial aspect of the present technology is in the exemplary embodiments provided by use of the reduced diameter of the pin such that the actual shear line point corresponding to the actual end 120 of combination pin 100 can not come into contact with the edge of the corresponding pin hole. In addition the actual shear line is displaced by predetermined distance 130 from the actual shear line so that, even if an attacker is able to detect edge contact, the attacker does not know how far, or even if the attacker should, offset the pin to bring the actual shear line into alignment with lock shear line surface 320 (FIG. 4).

Further, noting that driver pin 200 may also be provided with a step 210 as previously mentioned, an attacker would not be able to determine whether any edge contact, even if detected, was from edge contact with either of a driver pin or a combination pin, thus adding to the uncertainty as to whether or not to displace such pin, and in which direction, all the attacker is attempting to pick the lock.

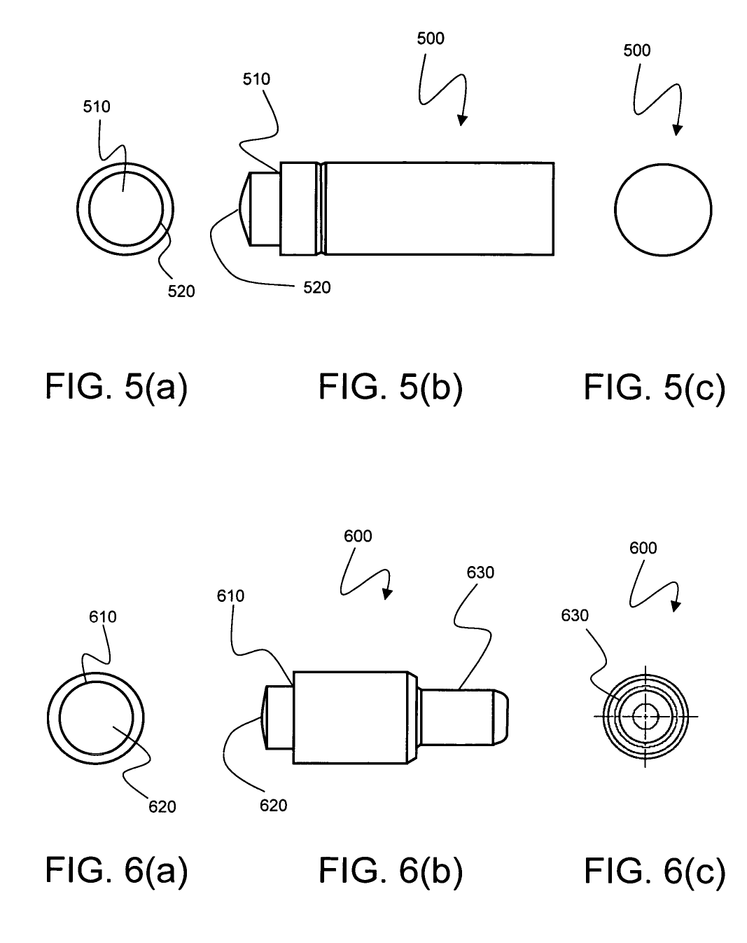

With reference to FIGS. 5(a), 5(b), and 5(c), there are illustrated left end, side, and right end views of an exemplary present combination pin 500 similar to that illustrated in FIG. 1. As may be seen, combination pin 500 is provided with a step 510 in the designated left end of the pin 500. In addition, left end 520 of pin 500 is slightly dome shaped to allow for a smoother sliding interaction between such combination pin and its corresponding driver pin. Generally speaking, such slightly dome shaped feature may be provided with/included in various present embodiments and practices of the present subject matter.

With reference to FIGS. 6(a), 6(b), and 6(c), there are illustrated left end, side, and right end views of an exemplary present driver pin 600 similar to that illustrated in FIG. 2. As may be seen, driver pin 600 is provided with a step 610 in the designated left end of the pin 600. In addition, left end 620 of pin 600 is slightly dome shaped to allow for a smoother sliding interaction between the driver pin and its corresponding combination pin. Right end portion 630 of driver pin 600 may be slightly reduced in diameter to allow for partial insertion of driver pin 600 in the end portion of a spring, not here illustrated but similar to springs 840, 842, and 844 as illustrated in FIG. 7(b). Generally speaking, such slightly dome shaped feature and/or such slightly reduced diameter end feature may be provided with/included in various present embodiments and practices of the present subject matter.

Referring back to FIG. 3, an additional aspect of certain embodiments of the present technology will be discussed. As previously noted, FIG. 3 illustrates an isometric generally front view of an exemplary top cylinder 300 as may be employed in constructing a lock in accordance with the present technology. One aspect of certain embodiments of the present technology is to provide a mechanism whereby a lock attacker may be prevented from inserting soft, impressionable materials fully into the lock so as to obtain an impression of the shear plane of the lock. Non-exclusive examples of soft, impressionable materials to be so excluded include soft end pens, business card, and similar items

In an exemplary embodiment of the present subject matter, soft, impressionable material may be prevented from being fully inserted into the lock structure by providing one or more protrusions exemplarily illustrated as protrusion 322. Protrusion 322 may correspond to one or more solid posts and may be positioned in the same bolt pattern and correspond in approximate size to the pin-tumblers such that they do not disturb the interface between the operating and master keys that may be used with the lock.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An axial pin tumbler lock with anti-pick features for inhibiting attack, said lock comprising:
(a) a cylinder housing defining a longitudinal axis, said cylinder housing including respective top and bottom cylinder portions having a common shear plane formed therebetween for rotatable movement of said cylinder portions relative to one another about said longitudinal axis, for placing said lock alternately into locked and unlocked positions thereof;
(b) at least one pair of alignable grooves formed in said respective cylinder portions, longitudinally aligned along said longitudinal axis;
(c) at least one pair of tumbler pins comprising a combination and driver pin pair, slidably received respectively in said alignable grooves, with said combination pin received primarily in said top cylinder portion and said driver pin received primarily in said bottom cylinder portion such that placement of the junction between said combination and driver pin pair at said common shear plane permits relative rotatable movement of said top and bottom cylinder portions;
(d) spring means for biasing said driver pin towards said combination pin;
(e) anti-pick means for inhibiting an attacker's ability to determine a shear line plane for said combination and driver pin pair by moving the contact point felt by an attacker to a plane different from that of said common shear plane.

2. An axial pin tumbler lock with anti-pick features for inhibiting attack as in claim 1, wherein said anti-pick means comprises a relatively reduced diameter step section formed on at least one of said combination and driver pins.

3. An axial pin tumbler lock with anti-pick features for inhibiting attack as in claim 2, wherein said relatively reduced diameter step section is formed a predetermined distance from an end of said at least one of said combination and driver pins.

4. An axial pin tumbler lock with anti-pick features for inhibiting attack as in claim 3, wherein said end of said at least one of said combination and driver pins is at least slightly curved, so as to provide relatively smoother sliding interaction thereof with other components of said lock.

5. An axial pin tumbler lock with anti-pick features for inhibiting attack as in claim 2, wherein said relatively reduced diameter step section is formed on said combination pin of said combination and driver pin pair.

6. An axial pin tumbler lock with anti-pick features for inhibiting attack as in claim 2, wherein said relatively reduced diameter step section is formed on said driver pin of said combination and driver pin pair.

7. An axial pin tumbler lock with anti-pick features for inhibiting attack as in claim 2, wherein said relatively reduced diameter step section is formed on both of said combination and driver pins of said combination and driver pin pair.

8. An axial pin tumbler lock with anti-pick features for inhibiting attack as in claim 1, wherein said spring means comprises a spring received with said driver pin in one of said at least one pair of alignable grooves formed in said bottom cylinder portions, longitudinally aligned along said longitudinal axis.

9. An axial pin tumbler lock with anti-pick features for inhibiting attack as in claim 8, wherein an end portion of said driver pin has a relatively reduced diameter portion for partial insertion of said driver pin into a corresponding end portion of said spring.

10. An axial pin tumbler lock with anti-pick features for inhibiting attack as in claim 1, further comprising:
a plurality of pairs of said alignable grooves, formed in said respective cylinder portions, longitudinally aligned along said longitudinal axis; and
a corresponding plurality of pairs of said tumbler pins comprising respective associated combination and driver pins for each of said pairs, slidably received respectively in said corresponding plurality of said alignable grooves, with said combination pins received primarily in said top cylinder portion and said driver pins received primarily in said bottom cylinder portion such that placement of the junctions between said respective combination and driver pin pairs at said common shear plane permits relative rotatable movement of said top and bottom cylinder portions, for placing said lock alternately into locked and unlocked positions thereof.

11. An axial pin tumbler lock with anti-pick features for inhibiting attack as in claim 10, wherein said anti-pick means comprises a plurality of relatively reduced diameter step sections respectively formed on a plurality of said combination and driver pins.

12. An axial pin tumbler lock with anti-pick features for inhibiting attack as in claim 11, wherein said relatively reduced diameter step sections are formed respective predetermined distances from respective ends of said plurality of said combination and driver pins, and wherein said respective predetermined distances are separately determined.

13. An axial pin tumbler lock with anti-pick features for inhibiting attack as in claim 11, wherein said respective ends of said plurality of said combination and driver pins are at least slightly curved, so as to provide relatively smoother sliding interaction thereof with other components of said lock.

14. An axial pin tumbler lock with anti-pick features for inhibiting attack, said lock comprising:
(a) a cylinder housing defining a longitudinal axis, said cylinder housing including respective top and bottom cylinder portions having a common shear plane formed therebetween for rotatable movement of said cylinder portions relative to one another about said longitudinal axis, for placing said lock alternately into locked and unlocked positions thereof;
(b) a plurality of pairs of alignable grooves, formed in said respective cylinder portions, longitudinally aligned along said longitudinal axis;
(c) a corresponding plurality of pairs of tumbler pins comprising respective associated combination and driver pins for each of said pairs, slidably received respectively in said corresponding plurality of said alignable grooves, with said combination pins received primarily in said top cylinder portion and said driver pins received primarily in said bottom cylinder portion such that placement of the junctions between said respective combination and driver pin pairs at said common shear plane permits relative rotatable movement of said top and bottom cylinder portions, for placing said lock alternately into locked and unlocked positions thereof;
(d) spring means for biasing said driver pins towards said respectively associated combination pins;
(e) a plurality of relatively reduced diameter step sections respectively formed on a plurality of said combination and driver pins for moving the contact points felt by an attacker to one or more planes different from that of said common shear plane, so as to inhibit an attacker's ability to determine a shear line plane for a given combination and driver pin pair.

15. An axial pin tumbler lock with anti-pick features for inhibiting attack as in claim 14, wherein said relatively reduced diameter step sections are formed respective predetermined distances from respective ends of said plurality of said combination and driver pins, and wherein said respective predetermined distances are separately determined.

16. An axial pin tumbler lock with anti-pick features for inhibiting attack as in claim 15, wherein said respective ends of said plurality of said combination and driver pins are at least slightly curved, so as to provide relatively smoother sliding interaction thereof with other components of said lock.

17. An axial pin tumbler lock with anti-pick features for inhibiting attack as in claim 14, wherein said spring means comprises a corresponding plurality of springs received respectively with said driver pins in said alignable grooves formed in said bottom cylinder portion, longitudinally aligned along said longitudinal axis.

18. An axial pin tumbler lock with anti-pick features for inhibiting attack as in claim 17, wherein respective end portions of said driver pins have relatively reduced diameter portions for partial insertion of said driver pins into corresponding end portions of associated springs.

19. An axial pin tumbler lock with anti-pick features for inhibiting attack as in claim 14, wherein the lengths of said combination pins are respectively predetermined.

20. An axial pin tumbler lock with anti-pick features for inhibiting attack as in claim 14, further including at least one protrusion defined by said cylinder housing and situated for preventing a lock attacker from inserting soft, impressionable materials adequately into the lock so as to obtain an impression of the shear plane of the lock.

21. A method for providing a tumbler lock with anti-pick features for inhibiting attack, said method comprising:
providing a lock, such lock having a main housing defining respective portions having a common pin shear plane formed therebetween for movement of such portions relative to one another, for placing said lock alternately into locked and unlocked positions thereof, having at least one pair of tumbler pins comprising a combination and driver pin pair and movably received in such housing such that placement of the junction between such combination and driver pin pair at the common pin shear plane permits relative movement of the respective housing portions; and
providing a relatively reduced diameter step section formed on at least one of the combination and driver pins for moving the contact point felt by an attacker to a plane different from that of said common pin shear plane, so as to inhibit an attacker's ability to determine a shear line plane for such combination and driver pin pair.

22. A method for providing a tumbler lock with anti-pick features for inhibiting attack as in claim 21, wherein said step of providing a lock further includes:
providing such main housing for defining a longitudinal axis and for providing such respective portions thereof for rotatable movement of such portions relative to one another about such longitudinal axis;
providing at least one pair of alignable grooves formed in such housing portions and longitudinally aligned along such longitudinal axis; and
providing such at least one pair of tumbler pins so that such combination and driver pin pair are slidably received respectively in such alignable grooves such that placement of the junction between such combination and driver pin pair at the common pin shear plane permits relative rotatable movement of the respective housing portions.

23. A method for providing a tumbler lock with anti-pick features for inhibiting attack, as in claim 22, wherein said step of providing a lock further includes:
providing such lock as an axial pin tumbler lock;
providing such housing as a cylinder with respective top and bottom cylinder portions; and
providing such a lock having spring means for biasing the driver pin towards the combination pin.

24. A method for providing a tumbler lock with anti-pick features for inhibiting attack, as in claim 23, wherein said step of providing a relatively reduced diameter step section includes forming said relatively reduced diameter step section a predetermined distance from an end of such at least one of such combination and driver pins.

25. A method for providing a tumbler lock with anti-pick features for inhibiting attack, as in claim 24, wherein said step of providing a lock further includes providing such end of such at least one of the combination and driver pins so as to be at least slightly curved, so as to provide relatively smoother sliding interaction thereof with other components of such lock.

26. A method for providing a tumbler lock with anti-pick features for inhibiting attack, as in claim 23, wherein said step of providing a lock further includes providing such a lock such that the spring means comprises a spring received with the driver pin in one of the at least one pair of alignable grooves formed in the bottom cylinder portion, longitudinally aligned along such longitudinal axis.

27. A method for providing a tumbler lock with anti-pick features for inhibiting attack, as in claim 26, wherein said step of providing a lock further includes providing an end portion of such driver pin with a relatively reduced diameter portion for partial insertion of such driver pin into a corresponding end portion of such spring.

28. A method for providing a tumbler lock with anti-pick features for inhibiting attack, as in claim 23, wherein said step of providing a lock further includes:
providing a plurality of pairs of such alignable grooves, formed in the respective cylinder portions, longitudinally aligned along such longitudinal axis; and
providing a corresponding plurality of pairs of such tumbler pins comprising respective associated combination and driver pins for each of such pairs, slidably received respectively in such corresponding plurality of the alignable grooves, with the combination pins received primarily in the top cylinder portion and the driver pins received primarily in the bottom cylinder portion such that placement of the junctions between such respective combination and driver pin pairs at the common shear plane permits relative rotatable movement of the top and bottom cylinder portions, for placing such lock alternately into locked and unlocked positions thereof; and
wherein said step of providing a relatively reduced diameter step section includes providing a plurality of relatively reduced diameter step sections respectively formed on a plurality of such combination and driver pins.

29. A method for providing a tumbler lock with anti-pick features for inhibiting attack, as in claim 28, wherein:
said step of providing a plurality of relatively reduced diameter step sections includes forming said plurality of relatively reduced diameter step sections respective predetermined distances from respective ends of the plurality of such combination and driver pins, and with such respective predetermined distances separately determined; and
wherein said step of providing a lock further includes forming the respective ends of the plurality of such combination and driver pins at least slightly curved, so as to provide relatively smoother sliding interaction thereof with other components of such lock, and includes providing at least one protrusion defined by the cylinder housing and situated for preventing a lock attacker from inserting soft, impressionable materials adequately into the lock so as to obtain an impression of the shear plane of the lock.
